(19) United States
(12) Patent Application Publication
(10) Pub. No.: US 2016/0057574 A1
(43) Pub. Date: Feb. 25, 2016

(54) SYSTEM FOR RECOGNIZING PASSENGER AND BOARDING POSITION IN VEHICLE

(71) Applicant: HYUNDAI MOTOR CORPORATION, Seoul (KR)

(72) Inventor: Un Kyu PARK, Seoul (KR)

(21) Appl. No.: 14/561,064

(22) Filed: Dec. 4, 2014

(30) Foreign Application Priority Data
Aug. 25, 2014 (KR) 10-2014-0110937

(51) Int. Cl. H04W 4/02; H04W 40/24; H04L 29/08

(52) U.S. Cl. CPC H04W 4/021; H04L 67/12; H04W 40/244; H04W 84/12

(57) ABSTRACT

A system for recognizing a passenger and a boarding position in a vehicle includes a wireless signal interface included in the vehicle and including a transmitter transmitting a wireless signal and a receiver receiving the wireless signal and other wireless signals; a beacon signal analyzer configured to analyze a beacon signal which is broadcast from a wireless terminal and is received by the receiver; a wireless signal analyzer configured to analyze the wireless signal which is transmitted from the transmitter and is received by the receiver; a passenger determiner configured to determine who the passenger of the vehicle is on an analysis result of the beacon signal analyzer; and a passenger position determiner configured to determine the boarding position of the passenger in the vehicle based on an analysis result of the wireless signal analyzer.

### CROSS-REFERENCE TO RELATED APPLICATION

This application is based on and claims the benefit of priority to Korean Patent Application No. 10-2014-0110937, filed on Aug. 25, 2014 in the Korean Intellectual Property Office, the disclosure of which is incorporated herein in its entirety by reference.

### TECHNICAL FIELD

The present disclosure relates to a system for recognizing a passenger and a boarding position in a vehicle capable of recognizing the passenger boarding a vehicle and the boarding position of the passenger in a vehicle by using a wireless signal transmitted and received in the vehicle.

### BACKGROUND

With the development of a vehicle related technology, functions of sensing a state of passengers in a vehicle for user convenience and safety have been added and improved. For example, a function of sensing whether a passenger boards a vehicle and displaying a warning about wearing of a seat belt with a warning sound, and the like has been developed. Further, a function of automatically controlling whether an airbag module is deployed depending on whether a passenger boards a vehicle and controlling a size of the airbag module by recognizing an adult and an infant depending on a load has been developed. Further, functions of sensing positions or temperature of passengers in a vehicle to automatically control a cooling and heating system depending on the positions have been developed.

The related art uses a load sensor for sensing whether a passenger boards a vehicle and a load of the passenger. However, the load sensor has a malfunction problem of performing the sensing operation even on an object, not on a person and therefore an infrared sensor such as an infrared camera sensing only a human body is complementarily used.

Further, to apply an emotional air conditioning system depending on a position of a passenger in a vehicle, temperature is measured depending on the position of the passenger in the vehicle using a plurality of indoor temperature measuring sensors, and the like.

Therefore, to recognize a state of a passenger in a vehicle for displaying a warning about the wear of the seat belt, controlling the airbag module, and controlling the air conditioning system, a need exists to complexly use the load sensor, the infrared sensor, and the temperature measuring sensor as described above.

### SUMMARY

The present disclosure has been made to solve the above-mentioned problems occurring in the prior art while advantages achieved by the prior art are maintained intact.

An aspect of the present disclosure provides a system for recognizing a passenger and a boarding position of the passenger in a vehicle capable of recognizing the passenger boarding the vehicle and the boarding position of the passenger in a vehicle by using a wireless signal transmitted and received in the vehicle.

According to an exemplary embodiment of the present disclosure, a system for recognizing a passenger and a boarding position in a vehicle includes a wireless signal interface included in the vehicle and including a transmitter transmitting a wireless signal and a receiver receiving the wireless signal and other wireless signals; a beacon signal analyzer configured to analyze a beacon signal which is broadcast from a wireless terminal and is received by the receiver; a wireless signal analyzer configured to analyze the wireless signal which is transmitted from the transmitter and is received by the receiver; a passenger determiner configured to determine who the passenger of the vehicle is on an analysis result of the beacon signal analyzer; and a passenger position determiner configured to determine the boarding position of the passenger in the vehicle based on an analysis result of the wireless signal analyzer.

The beacon signal analyzer or the passenger determiner may recognize the wireless terminal based on a MAC address or a connection request list included in the beacon signal and determine who the passenger is based on the recognized wireless terminal.

The wireless signal analyzer or the passenger position determiner may determine the boarding position of the passenger based on at least one of signal distortion, signal attenuation, Doppler effect, signal strength indication (SSI), and multi-path signal analysis of the wireless signal which is transmitted from the transmitter and is received by the receiver.

The wireless signal may be a WiFi signal, the transmitter may transmit the WiFi signal, the receiver may receive the WiFi signal, and the wireless signal interface may be a WiFi interface.

The wireless signal analyzer or the passenger position determiner may determine the boarding position based on at least any one of a change pattern of the wireless signal due to a body of the passenger which is positioned at a boarding point of the vehicle, a change pattern of the wireless signal due to a motion of the body of the passenger, and a change pattern of the wireless signal which is generated when the passenger gets off, which are patterns of the received wireless signals when there are no passengers in the vehicle.

The system may further include a vehicle information provider included in the vehicle and detecting information on the vehicle; and a passenger number and position determiner configured to determine the passenger and the boarding position in the vehicle based on all of a determination result of the passenger determiner, a determination result of the passenger position determiner, and information regarding the vehicle provided from the vehicle information provider.

The system may further include user profiles configured to be pre-stored with information of a user using the vehicle; and a user preference setting configured to provide a personalization function of devices included in the vehicle based on a determination result of the passenger determiner, a determination result of the passenger position determiner, or the information of the user.

The system may further include a controller configured to sequentially connect devices to wireless terminals based on priority based on the boarding position which is a determination result of the passenger position determiner, in connecting the devices included in the vehicle to the wireless terminals.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram illustrating a system for recognizing a passenger and a boarding position in a vehicle according to an exemplary embodiment of the present disclosure;

FIG. 2 is a diagram illustrating that a WiFi signal is transmitted and received through a WiFi interface in a vehicle, in the system for recognizing a passenger and a boarding position in a vehicle according to the exemplary embodiment of the present disclosure; and

FIG. 3 is a diagram illustrating a beacon signal transmitted from a wireless terminal in a vehicle, in the system for recognizing a passenger and a boarding position in a vehicle according to the exemplary embodiment of the present disclosure.

### DETAILED DESCRIPTION

Advantages and features of the present disclosure and methods to achieve them will be elucidated from exemplary embodiments described below in detail with reference to the accompanying drawings. Therefore, the present disclosure is not limited to the exemplary embodiments set forth herein, but may be modified in many different forms. However, these embodiments are provided so that this disclosure will be thorough and complete, and will fully convey the technical spirit of the disclosure to those skilled in the art.

In the drawings, the exemplary embodiments of the present disclosure are not limited to the illustrated specific form, but in order to clearly understand and/or easily embody the present disclosure, configurations of the present disclosure will be enlarged in the accompanying drawings. Herein, specific terms have been used, but are just used for the purpose of describing the present disclosure and are not used for qualifying the meaning or limiting the scope of the present disclosure, which is disclosed in the appended claims.

In the present specification, terms ‘and/or’ are used as meaning including at least one of components arranged after and before any component. Further, expression ‘connected/coupled’ is used as a meaning including a case in which the parts are directly connected with each other and a case in which the parts are indirectly connected with each other with other elements interposed therebetween. Unless explicitly described to the contrary, a singular form includes a plural form in the present specification. In addition, components, steps, operations, and elements mentioned as by ‘comprise’ or ‘comprising’ used in the present specification do not exclude the existence or addition of one or more other components, steps, operations, and elements.

Hereinafter, exemplary embodiments of the present disclosure will be described in detail with reference to the accompanying drawings.

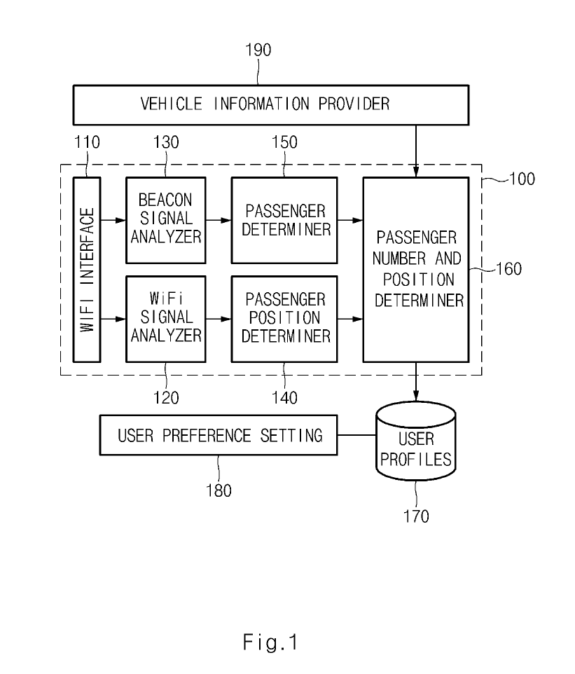

FIG. 1 is a diagram illustrating a system for recognizing a passenger and a boarding position in a vehicle according to an exemplary embodiment of the present disclosure. A vehicle to be described below includes an apparatus for transmitting and receiving a wireless signal. Herein, the wireless signal may be a WiFi signal, but is not limited thereto. However, for convenience of explanation, the WiFi signal is described as a wireless signal.

Referring to FIG. 1, a system 100 for recognizing a passenger and a boarding position in a vehicle includes a WiFi interface 110, a WiFi signal analyzer 120, a beacon signal analyzer 130, a passenger position determiner 140, and a passenger determiner 150. Further, the system 100 for recognizing a passenger and a boarding position in a vehicle further includes a passenger number and position determiner 160, user profiles 170, a user preference setting 180, and a vehicle information provider 190.

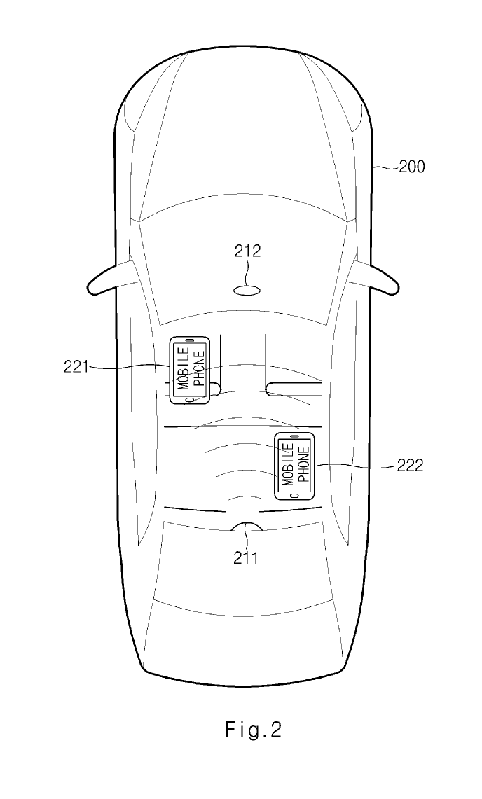

The WiFi interface 110 is equipped in the vehicle and includes a transmitter (not illustrated) configured to transmit the WiFi signal and a receiver (not illustrated) configured to receive the transmitted WiFi signal and other wireless signals. In this configuration, as illustrated in FIG. 2, the transmitter and the receiver may each be disposed at a rear and a front of the vehicle. Further, the WiFi signal received by the receiver may be a signal which is distorted or attenuated due to obstacles (e.g. a vehicle sheet, passengers in a vehicle) which are located in the vehicle while the WiFi signal transmitted from the transmitter passes through the inside of the vehicle.

The WiFi signal analyzer 120 analyzes the WiFi signal received by the receiver which is included in the WiFi interface 110. In detail, the WiFi signal analyzer 120 analyzes a waveform, a pattern, or the like of the received WiFi signal.

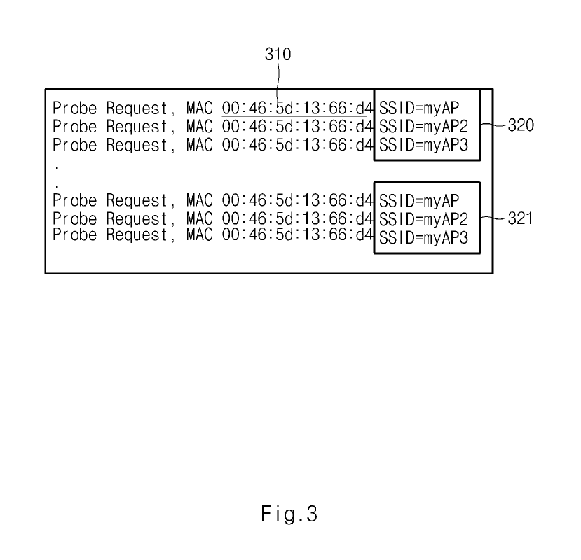

The beacon signal analyzer 130 analyzes beacon signals included in other wireless signals received by the receiver which is included in the WiFi interface 110. Herein, the beacon signal is a signal which is periodically broadcast to peripheral devices so as to connect a wireless terminal to an access point which is previously accessed. The beacon signal will be described in detail with reference to FIG. 3.

The passenger position determiner 140 determines boarding positions of passengers boarding a vehicle based on an analysis result of the WiFi signal analyzer 120. In detail, when a passenger boards a passenger seat, the WiFi signal transmitted through the transmitter included in the WiFi signal interface 110 determines the boarding position of the passenger using a signal distortion, and the like which is generated due to a body of the passenger boarding the passenger seat.

The passenger determiner 150 specifies the wireless terminal which broadcasts the beacon signal based on an analysis result of the beacon signal analyzer 130 and determines who a passenger possessing the specified wireless terminal is. In detail, the wireless terminal which broadcasts the corresponding beacon signal is specified based on unique information (for example, MAC address) of the wireless terminal included in the beacon signal.

In the system for recognizing a passenger and a boarding position in a vehicle according to the exemplary embodiment of the present disclosure, contents of a determination of a passenger and a boarding position will be described in detail.

First, the beacon signal analyzer 130 or the passenger determiner 150 specifies and recognizes the wireless terminal which broadcasts the corresponding beacon signal based on the MAC address which is the unique information of the wireless terminal included in the beacon signal received by the receiver or an access point connection request list which is retrieved by the wireless terminal. Further, it may be determined who the passengers of the vehicle are by specifying a passenger possessing the recognized wireless terminal.

Further, the WiFi signal analyzer 120 or the passenger position determiner 140 determines the boarding position of the passenger in the vehicle based on at least one of signal distortion, signal attenuation, Doppler effect, signal strength indication (SSI), and multi-path signal analysis of the WiFi signal which is transmitted from the transmitter and is received by the receiver. Herein, the signal distortion, and the like of the WiFi signal may be generated due to the body of the passenger boarding the vehicle or a motion of the body of the passenger.

Contents of the determination of the boarding position of the passenger will be described with reference to FIG. 2. FIG. 2 is a diagram illustrating that a WiFi signal is transmitted and received through a WiFi interface in a vehicle, in the system for recognizing a passenger and a boarding position in a vehicle according to the exemplary embodiment of the present disclosure.

A vehicle 200 includes a transmitter 211 transmitting the WiFi signal and a receiver 212 receiving the transmitted WiFi signal as the WiFi interface. Further, FIG. 2 illustrates the state in which passengers possessing mobile phones 221 and 222 are currently boarded in a driver's seat and a right back seat in the vehicle 200.

The WiFi signal transmitted from the transmitter 211 is distorted or attenuated due to the body of the passenger of the driver's seat possessing the mobile phone 221 and the body of the passenger of the back seat possessing the mobile phone 222 and the motions of the bodies of the passengers. Further, the so distorted or attenuated degree has a constant pattern depending on the boarding position of the vehicle 200 or the motion of the passenger at the corresponding boarding position.

Referring to FIGS. 1 and 2, in the system for recognizing a passenger and a boarding position in a vehicle, the WiFi signal analyzer 120 or the passenger position determiner 140 may determine the boarding position of the passenger boarding the vehicle based on at least any one of a change pattern of the received WiFi signal due to the body of the passenger which is positioned at a boarding point of the vehicle 200, a change pattern of the received WiFi signal due to the motion of the body of the passenger, and a change pattern of the received WiFi signal which is generated when the passenger gets off. These change patterns are based on the pattern of the WiFi signal received by the receiver 212 when there are no passengers in the vehicle 200.

FIG. 3 is a diagram illustrating the beacon signal transmitted from a wireless terminal in a vehicle, in the system for recognizing a passenger and a boarding position in a vehicle according to the exemplary embodiment of the present disclosure.

A probe request of the beacon signal includes a MAC address 310 which is the unique information of the wireless terminal and connection request lists 320 and 310 which are retrieved by the access point, which is previously accessed, from the wireless terminal. Thereby, in the system for recognizing a passenger and a boarding position in a vehicle according to the exemplary embodiment of the present disclosure, the beacon signal analyzer 130 or the passenger determiner 150 may specify and recognize the wireless terminal which broadcasts the corresponding beacon signal, such that it may be determined who the passenger possessing the corresponding wireless terminal is. Here, as illustrated in FIG. 3, the beacon signal analyzer 130 or the passenger determiner 150 may determine whether the wireless terminal broadcasting the corresponding beacon signal is a wireless terminal which is positioned inside the vehicle or a wireless terminal which is positioned outside the vehicle, based on the repetition of the same beacon signal.

Referring back to FIG. 1, the system for recognizing a passenger and a boarding position in a vehicle according to the exemplary embodiment of the present disclosure may further include the passenger number and position determiner 160 and the vehicle information provider 190.

The vehicle information provider 190 detects the information on the vehicle using various types of sensors, and the like which are included in the vehicle. For example, the information on the vehicle may include a speed and a position of the vehicle, a weight sensed on a seat, whether a vehicle door is opened or closed, and the like.

The passenger number and position determiner 160 more accurately determines who the passengers of the vehicle are and the boarding position of the corresponding passenger in the vehicle based on all of a determination result of the passenger determiner 150, a determination result of the passenger position determiner 140, and various information regarding the vehicle provided from the vehicle information provider 190.

Further, the system for recognizing a passenger and a boarding position in a vehicle according to the exemplary embodiment of the present disclosure may further include the user profiles 170 and the user preference setting 180.

The user profiles 170 pre-store the information of the user using the vehicle. The user of the vehicle may directly register his or her own information during the use process of the vehicle.

The user preference setting 180 provides a personalization function which adjusts various types of devices included in the vehicle to be fitted for the determined use, based on the determination result of the passenger determiner 150, the determination result of the passenger position determiner 140, and the information of the user stored in the user profiles 170. Here, an example of the adjustment of various types of devices which are included in the vehicle may include a handle position of a side mirror and a room mirror, an air conditioning apparatus, setting of an infortainment device, or the like.

Further, the system for recognizing a passenger and a boarding position in a vehicle according to the exemplary embodiment of the present disclosure may further include a controller referring to the determined boarding position, in connecting a device which may be connected to the wireless terminal such as the infortainment device included in the vehicle to the wireless terminal.

Describing in detail, in connecting the devices included in the vehicle to the wireless terminal, the controller may set priority depending on the boarding position which is the determination result of the passenger position determiner 140 described above, in connecting the infortainment device included in the vehicle to the wireless terminal. That is, based on the set priority, a connection of the wireless terminal positioned at a driver's seat having higher priority to the infortainment device is performed ahead of the wireless terminals positioned at other seats and when the connection is not possible, the wireless terminals having next priority may be sequentially connected to the infortainment device.

Consequently, the system for recognizing a passenger and a boarding position in a vehicle according to the exemplary embodiment of the present disclosure analyzes the wireless signal (WiFi signal) generated from the inside of the vehicle to determine who the passengers boarding the vehicle are or the boarding positions of the passengers, such that various types of devices included in the vehicle may be automatically set without the passengers performing the separate operation and the wireless terminal may be automatically connected based on priority.

As described above, according to the exemplary embodiments of the present disclosure, the system for recognizing a passenger and a boarding position in a vehicle may recognize the passenger boarding the vehicle and the boarding position of the passenger in the vehicle by using the wireless signal transmitted and received in the vehicle.

Hereinabove, although the exemplary embodiments of the present disclosure have been disclosed for illustrative purposes, those skilled in the art will appreciate that various modifications, additions and substitutions are possible, without departing from the scope and spirit of the present disclosure as disclosed in the accompanying claims Accordingly, the scope of the present disclosure is not construed as being limited to the described embodiments but is defined by the appended claims as well as equivalents thereto. Considering the above contents, if the modifications and changes of the present disclosure belong to the range of the following claims and equivalents, the present disclosure is considered to include the changes and modifications of the present disclosure.

What is claimed is:

1. A system for recognizing a passenger and a boarding position of the passenger in a vehicle, comprising:
a wireless signal interface included in the vehicle and including a transmitter transmitting a wireless signal and a receiver receiving the wireless signal and other wireless signals;
a wireless signal analyzer configured to analyze the wireless signal which is transmitted from the transmitter and is received by the receiver; and
a passenger position determiner configured to determine the boarding position of the passenger in the vehicle based on an analysis result of the wireless signal analyzer.

2. The system according to claim 1, wherein the wireless signal analyzer or the passenger position determiner determines the boarding position of the passenger based on at least one of signal distortion, signal attenuation, Doppler effect, signal strength indication (SSI), and multi-path signal analysis of the wireless signal which is transmitted from the transmitter and is received by the receiver.

3. A system for recognizing a passenger and a boarding position of the passenger in a vehicle, comprising:
a wireless signal interface included in the vehicle and including a transmitter transmitting a wireless signal and a receiver receiving the wireless signal and other wireless signals;
a beacon signal analyzer configured to analyze a beacon signal which is broadcast from a wireless terminal and is received by the receiver; and
a passenger determiner configured to determine who the passenger of the vehicle is based on an analysis result of the beacon signal analyzer.

4. The system according to claim 3, wherein the beacon signal analyzer or the passenger determiner recognizes the wireless terminal based on a MAC address or a connection request list included in the beacon signal and determines who the passenger is based on the recognized wireless terminal.

5. The system according to claim 1, wherein the wireless signal is a WiFi signal, and wherein
the transmitter transmits the WiFi signal,
the receiver receives the WiFi signal, and
the wireless signal interface is a WiFi interface.

6. The system according to claim 1, wherein the wireless signal analyzer or the passenger position determiner determines the boarding position based on at least any one of a change pattern of the wireless signal due to a body of the passenger which is positioned at a boarding point of the vehicle, a change pattern of the wireless signal due to a motion of the body of the passenger, and a change pattern of the wireless signal which is generated when the passenger gets off,
wherein the change patterns are based on the pattern of the received wireless signal when there are no passenger in the vehicle.

7. The system according to claim 1, further comprising:
a vehicle information provider included in the vehicle and configured to detect information on the vehicle; and
a passenger number and position determiner configured to determine the passenger or the boarding position in the vehicle based on all of a determination result of the passenger determiner, a determination result of the passenger position determiner, and information regarding the vehicle provided from the vehicle information provider.

8. The system according to claim 1, further comprising:
user profiles configured to be pre-stored with information of a user using the vehicle; and
a user preference setting configured to provide a personalization function of devices included in the vehicle based on a determination result of the passenger determiner, a determination result of the passenger position determiner, or the information of the user.

9. The system according to claim 1, further comprising:
a controller configured to sequentially connect devices to wireless terminals based on priority based on the boarding position which is a determination result of the passenger position determiner.
